(19) United States
(12) Patent Application Publication
(10) Pub. No.: US 2020/0196620 A1
(43) Pub. Date: Jun. 25, 2020

(54) OSMOTIC MILK CONCENTRATOR HAVING A NUTRIENT FORTIFIED DRAW SOLUTION

(71) Applicant: FLUID TECHNOLOGY SOLUTIONS (FTS), INC., Albany, OR (US)

(72) Inventors: Jason T. Arena, Albany, OR (US); John R. Herron, Corvallis, OR (US); George E. Monigold, Albany, OR (US); Keith A. Lampi, Albany, OR (US)

(21) Appl. No.: 16/677,197

(22) Filed: Nov. 7, 2019

Related U.S. Application Data
(60) Provisional application No. 62/756,844, filed on Nov. 7, 2018.

(51) Int. Cl. A23C 9/142; B01D 61/00; A23C 9/20

(52) U.S. Cl. CPC A23C 9/142; B01D 61/002; B01D 71/14; A23C 2210/202; A23C 9/206

(57) ABSTRACT

Embodiments disclosed herein relate to an osmotic milk concentrator having a nutrient fortified draw solution and related methods. The osmotic milk concentrator includes at least one draw material reservoir, at least one human milk reservoir, at least one semi-permeable membrane between the at least one draw material reservoir and the at least one human milk reservoir.

### CROSS-REFERENCE TO RELATED APPLICATIONS

This application claims priority to U.S. Application No. 62/756,844, filed on 7 Nov. 2018, the disclosures of which are incorporated herein, in their entirety, by this reference.

### BACKGROUND

Nutrient support for very low birth weight pre-term infants is critical for the infants. A balance is needed between providing sufficient nutrition while also mitigating the potential health complications that may arise from the immature state of a pre-term infant digestive and immune systems. Additional nutritional support is also important for other infants needing medical care such as, but not limited to, those with cardiac issues, respiratory issues, undergoing surgical procedures, and small for gestational age.

### SUMMARY

Embodiments disclosed herein relate to osmotic milk concentrator apparatus and systems, and related methods. In an embodiment, a method of concentrating human breast milk to increase nutritional content of the human breast milk per unit of volume or immunological content of the human breast milk per unit of volume thereof is disclosed. The method includes using an osmotic pressure difference between the human breast milk and one or more draw materials to concentrate the human breast milk. The one or more draw materials include at least one of a buffer, one or more sugars, one or more minerals, one or more salts, one or more proteins, one or more amino acids, one or more fatty acids, or any combinations thereof. The osmotic pressure difference occurs across at least one membrane, and the at least one membrane separates the human breast milk from the one or more draw materials such that water is removed from the human breast milk and transferred across the at least one membrane, and into the one or more draw materials. Material of the at least one membrane limits transfer of the one or more draw materials across the at least one membrane into the human breast milk to acceptable safe levels for feeding the human breast milk to an infant. The material of the at least one membrane limits transfer of human breast milk components across the at least one membrane, thereby reducing loss of nutrients or immunological components in the human breast milk.

In an embodiment, a milk concentrator apparatus includes at least one draw material reservoir, at least one human milk reservoir, and at least one semi-permeable membrane. The at least one draw material reservoir includes one or more draw materials, the one or more draw materials including at least one of a buffer, one or more sugars, one or more minerals, one or more salts, one or more proteins, one or more amino acids, or one or more fatty acids. The at least one semi-permeable membrane is between the at least one draw material reservoir and the at least one human milk reservoir.

In an embodiment, an apparatus for mitigating fouling during concentrating human breast milk is disclosed. The apparatus includes at least one forward osmosis membrane, at least one feed spacer, at least one draw spacer, a core tube with an interior plug around which the forward osmosis membrane, the at least one feed spacer, and the at least one draw spacer are wound, at least one first channel through which the human breast milk flows on a first side of the at least one forward osmosis membrane, and at least one second channel through which draw solution flows on a second side of the at least one forward osmosis membrane opposite from the human milk side. The core tube has an entrance for concentrated draw solution and an exit for diluted draw solution with the diluted draw solution containing water removed from the human breast milk.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a schematic diagram of a milk concentrator apparatus, according to an embodiment.

FIG. 2 is an isometric view of a milk concentrator apparatus, according to an embodiment.

### DETAILED DESCRIPTION

Embodiments of this disclosure relate to a method of concentrating human breast milk to increase the nutritional content of the human breast milk per unit of volume or the immunological content of the human breast milk per unit of volume thereof. The method includes using an osmotic pressure difference between the human breast milk and one or more draw materials to concentrate the human breast milk. The draw materials include at least one of a buffer, one or more sugars, one or more minerals, one or more salts, one or more proteins, one or more amino acids, or one or more fatty acids. The use of different draw materials or different combinations of draw materials may enhance the concentration process. The osmotic pressure difference may occur across at least one membrane separating the human breast milk from the one or more draw materials such that water is removed from the human breast milk and transferred across the membrane and into the one or more draw materials. Materials of the at least one membrane may limit transfer of the one or more draw materials across the at least one membrane into the human milk to acceptable safe levels for feeding the milk to an infant. The materials of the at least one membrane also may limit transfer of human breast milk components across the at least one membrane to ensure minimal loss of nutrients or immunological components.

Embodiments of the method of concentrating human breast milk to increase the nutritional content of the human breast milk per unit of volume or the immunological content of the human breast milk per unit of volume thereof may include one or more of the following. The materials of the at least one membrane may be configured to transfer a portion of one or more potential over-concentrating components from the human breast milk, through the at least one membrane, and to the one or more draw materials. The one or more potential over-concentrating components may include lactose. The material of the at least one membrane, exclusive of backing material, may include at least one of cellulose or cellulose ester. The material of the at least one membrane may be spiral wound, thereby providing a large or increased surface contact area to enhance transfer of water out of the human breast milk. The method may include subjecting the human breast milk to a low pressure, less than 30 psi, preferably less than 15 psi, to enhance flow through the spiral wound membrane. The materials of the at least one membrane may be formed into an enclosure which holds at least the one or more draw materials. The enclosure may be a pouch. The enclosure may hold the one or more draw materials and water transferred from the human breast milk across the at least one membrane. The material of the at least one membrane may be formed into an enclosure which holds the human breast milk. The method may include collecting the human breast milk from the mother of the infant for which the concentrated milk is intended. The method may include collecting the human breast milk from one or more donors that are not the mother of the infant for which the concentrated milk is intended. The one or more draw materials may include at least one of a powder, a paste, or a solution. The one or more membranes may include an active membrane surface area that is available to be exposed to the human milk, the active membrane surface area being at least 50 square cm, or preferably at least 100 square cm.

Embodiments of this disclosure relate to an apparatus for concentrating human breast milk to increase the nutritional content of the human breast milk per unit of volume or the immunological content of the human breast milk per unit of volume thereof. The apparatus includes at least one draw material reservoir, at least one human milk reservoir, and at least one semi-permeable membrane between the at least one draw material reservoir and the at least one human milk reservoir. The draw material reservoir and the milk reservoir contact or otherwise connect to opposite sides of at least one semi-permeable membrane. The draw material in the draw material reservoir and/or the milk in the milk reservoir may contact opposite sides of the at least one semi-permeable membrane. The at least one semi-permeable membrane is formed into a pouch and the draw material reservoir is inside the pouch.

Embodiments of the apparatus for concentrating human breast milk to increase the nutritional content of the human breast milk per unit of volume or the immunological content of the human breast milk per unit of volume thereof may include one or more of the following. The apparatus may include multiple pouches formed from the membrane. The multiple pouches may be either tethered, independent, or a combination thereof.

Embodiments of this disclosure also relate to an apparatus for concentrating human breast milk to increase the nutritional content of the human breast milk per unit of volume or the immunological content of the human breast milk per unit of volume thereof. The apparatus includes at least one draw material reservoir, at least one human milk reservoir, and at least one semi-permeable membrane between the at least one draw material reservoir and the at least one human milk reservoir. The draw material reservoir and the milk reservoir contact or otherwise connect to opposite sides of at least one semi-permeable membrane. The draw material in the draw material reservoir and/or the milk in the milk reservoir may contact opposite sides of the at least one semi-permeable membrane. The at least one semi-permeable membrane is formed into a pouch and the human milk reservoir is inside the pouch.

Embodiments of this disclosure also relate to an apparatus for concentrating human breast milk to increase the nutritional content of the human breast milk per unit of volume or the immunological content of the human breast milk per unit of volume thereof. The apparatus includes at least one draw material reservoir, at least one human milk reservoir, and at least one semi-permeable membrane between the at least one draw material reservoir and the at least one human milk reservoir. The membrane is formed into a spiral wound element incorporating flow channels for the human breast milk and separate flow channels for a draw solution. The draw solution reservoir and the milk reservoir connect to opposite sides of the semi-permeable membrane. The flow channels create paths along which water from the human milk crosses the at least one semi-permeable membrane and mixes with the draw solution, thereby diluting the draw solution and concentrating the human breast milk.

Embodiments of this disclosure also relate to a method of mitigating fouling of a membrane during concentrating human breast milk via an osmotic process. The method includes generating shear in a membrane pouch exerted on at least one of the human breast milk or a draw solution by circulation, agitation, vibration, or sonication of the at least one of the human breast milk or the draw solution, thereby mitigating fouling of the membrane and loss of nutrients. The method also may include providing instruction to the user to agitate, vibrate, sonicate, mix or otherwise enhance circulation of either the human milk or the draw material or both to mitigate fouling of the membrane by generating shear in a membrane pouch exerted on the breast human milk, the draw solution, or both.

Embodiments of this disclosure relate to an apparatus for mitigating fouling during concentrating human breast milk via an osmotic process. The apparatus includes at least one forward osmosis membrane, at least one feed spacer, at least one draw spacer, a core tube with interior plug around which the forward osmosis membrane and spacers are wound, a first channel, and a second channel. The human breast milk flows through the first channel on a first side of the forward osmosis membrane. The draw solution flows through the second channel on a second side of the forward osmosis membrane opposite to the first side. The core tube includes an entrance for concentrated draw solution and an exit for diluted draw solution, with the draw solution containing water removed from the human breast milk. The spacing and velocity of at least the human milk side of the membrane creates shear to mitigate fouling.

Embodiments of this disclosure also relate to a method of concentrating human breast milk. The method includes using osmotic pressure difference between the human breast milk and a draw material to remove water from the human milk. The draw material is tailored or metered such that a maximum osmolality of the human breast milk is 400 mOsm/kg. In some embodiments, brix or other properties of the human milk is measured as the value is used to select the draw material to achieve the desired end concentration.

Embodiments of this disclosure also relate to a method of manufacturing an osmotically driven device for concentrating human milk. The method includes having the pouch assembled with at least one section of the pouch including membrane materials for forward osmosis that can be used to separate the human milk from osmotic draw material. The method also includes having the osmotic draw material secured inside the pouch. The method also includes having at least one pouch with osmotic draw material packaged inside a container, such as a barrier film bag or milk storage device, that protects the contents from mechanical and environmental damage. The method includes having user instructions available with the device to guide appropriate use of the product to achieve the desired amount of water removal from the human milk. The pouch includes adequate surface area and the draw materials includes adequate osmotic potential to concentrate the milk to the desired concentration, between 20%-50%, based on the known volume of milk, in less than 6 hours, preferably 2 hours or less, at 25 degrees Celsius or less, preferably at refrigeration temperature.

Feeding Considerations for Pre-Term Infants

Nutrient support for very low (<1500 g) birth weight pre-term infants presents one of the intractable problems in the care of this fragile and inherently vulnerable population. At fore of this issue is the need to balance an infant's short- and long-term welfare, specifically providing sufficient nutrition while mitigating the potential health complications that may arise from the immature state of a pre-term infant's digestive and immune systems (Neu and Walker, 2011). One potentially deadly condition that commonly afflict pre-term infants is necrotizing enterocolitis, a gastrointestinal condition characterized by intestinal injury, inflammation, and necrosis (Patel and Denning, 2013). Necrotizing enterocolitis has been described as being “one of the greatest scourges of neonatal intensive care” (Hall, 2017) with serious health implications. Overall, necrotizing enterocolitis afflicts from 6-11% of all very low birth weight infants and is fatal in 20-40% of cases (Sharma and Hudak, 2013; Ramani and Ambalavana, 2013).

One of the greatest multipliers in the risk of a pre-term infant in developing this condition is the reception of non-human derived nutrition (e.g. formula) (Lucas and Cole, 1990). The use of donated human milk as a supplement or alternative to the mother's supply appears to provide reduced risk of necrotizing enterocolitis when compared to non-human derived nutritional sources; however, there is a noted reduction of nutritional content in donated milk as result of milk aging and the later stages lactation from which the donor milk is most likely derived (Hibberd et al., 1982; Maffei and Schanler, 2017; McNelis and Poindexter, 2017). Notable amongst the loss of nutrients is a loss of vitamin C, lysozyme, lactoferrin, lipase activity, secretory immunoglobin A (sIgA), and sIgA antibody (Heiman and Schanler, 2007). Despite this drawback whole or partial use of donor milk is likely the best available option as only 30% of mothers of pre-term infants were able to provide sufficient milk for infant feedings throughout hospitalization in the neonatal intensive care unit (Maffei and Schanler, 2017). In either case, both mother's milk and donor milk lack, to varying degrees, adequate nutritional content for the digestive system capacity of extremely low birth weight pre-term infants. Because of the increased risk of necrotizing enterocolitis from non-human derived nutritional sources, there is the necessity to develop techniques that can improve the nutritional content of human derived milk sources. Foremost amongst those pre-existing commercial offerings are milk fortifying additives in powder or concentrated liquid form that can be added to human derived milk to markedly increase its nutritional content.

Nutritional Requirements for Very Low Birthweight Pre-Term Infants

Upon delivery of a very low birthweight pre-term infant, parental nutrition is initiated within the first 24 to 30 hours of birth (Su, 2014). Parental nutrition refers to the intravenous delivery of nutrients comprising carbohydrates, protein, fats, electrolytes, minerals, vitamins, and micronutrients (Ditzenberger, 2014). Parental nutrition is intended as a short-term nutritional solution as a transition of the pre-term infant from the in-utero environment to enteral (feeding by mouth) nutritional intake of a term infant, which occurs in the first few days of life (Su, 2014; Ditzenberger, 2014). A limitation in the delivery of nutrients to pre-term infants is the capacity of their gastrointestinal system when extracting nutrition from sources natively intended for term infants, including breast milk from the mother. Current (as of 2014) nutritional recommendations for enteral nutrition of pre-term infants is shown in Table 1 and provides an objective for devising routes of delivering sufficient nutritional for the pre-term infant.

TABLE 1
Recommended nutritional content of enteral
feedings compiled by Ditzenberger (2014).

Infant Weight

| Nutrient/Element | <1000 g | 1000-1500 g |
|---|---|---|
| Fluid (mL/kg/d) | 140-180 | 135-190 |
| Energy (kcal/kg/d) | 130-150 | 110-130 |
| Protein (g/kg/d) | 3.8-4.4 | 3.4-4.2 |
| Carbohydrate (g/kg/d) | 9-20 | 7-17 |
| Fat (g/kg/d) | 6.2-8.4 | 5.3-7.2 |
| Sodium (mg/100 kcal) | 38-58 | 38-58 |
| Potassium (mg/100 kcal) | 65-100 | 65-100 |
| Chloride (mg/100 kcal) | 59-89 | 59-89 |
| Calcium (mg/100 kcal) | 100-192 | 100-192 |
| Phosphorous (mg/100 kcal)¹ | 40-80 | 46-127 |
| Magnesium (mg/100 kcal)¹ | 5.3-11.5 | 6.1-13.6 |
| Iron (mg/kg/d) | 2-4 | 2-4 |
| Vitamin A (IU/100 kcal) | 700-1500 | 700-1500 |
| Vitamin D (IU/100 kcal) | 150-400 | 150-400 |
| Vitamin E (IU/100 kcal) | 6-12 | 6-12 |
| Vitamin K1 (μg/100 kcal) | 8-10 | 8-10 |
| Ascorbate (mg/100 kcal) | 18-24 | 18-24 |
| Thiamine (μg/100 kcal) | 180-240 | 180-240 |
| Riboflavin (μg/100 kcal) | 250-360 | 250-360 |
| Pyridoxine (μg/100 kcal) | 150-210 | 150-210 |
| Niacin (mg/100 kcal) | 3.6-4.8 | 3.6-4.8 |
| Pantothenate (mg/100 kcal) | 1.2-1.7 | 1.2-1.7 |
| Biotin (μg/100 kcal) | 3.6-6 | 3.6-6 |
| Folate (μg/100 kcal) | 25-50 | 25-50 |
| Vitamin B12 (μg/100 kcal) | 0.3 | 0.3 |
| Zinc (μg/100 kcal) | 800-1100 | 800-1100 |
| Copper (μg/100 kcal) | 100-125 | 100-125 |
| Selenium (μg/100 kcal) | 1.3-2.5 | 1.3-2.5 |
| Manganese (μg/100 kcal) | 0.7-7.75 | 0.7-7.75 |
| Molybdenum (μg/100 kcal) | 0.3 | 0.3 |
| Iodine (μg/100 kcal) | 10-60 | 10-60 |
| Chromium (μg/100 kcal) | 0.1-0.4 | 0.1-0.4 |
| Taurine (mg/100 kcal) | 4.5-9.0 | 4.5-9.0 |
| Carnitine (mg/100 kcal) | ~2.9 | ~2.9 |
| Inositol (mg/100 kcal) | 27-67 | 27-67 |
| Choline (mg/100 kcal) | 12-23 | 12-23 |

¹Values attributed to Tsang et al. (2005), reported in Tudehope et al. (2013).

One of the clearest limitations of the data shown in Table 1 is that it relates nutritional guidelines to daily intake by an infant based upon body mass. While this does not directly correlate to the nutritional content of milk or formula given to an infant, it can be used to extract target concentrations for key nutrients in foodstuff (either milk, fortified milk, or formula) for pre-term infants. A comparison of some of these nutrients relative to reported concentrations in human breast milk as impacted by duration of lactation is shown in Table 2 and clearly show that primary nutrient concentrations from mother's milk and donated human milk are insufficient to meet the nutrient needs of a pre-term infant.

TABLE 2
Target concentrations of some nutrients in human milk compared
to breast milk as impacted by stage of lactation.

| | Infant weight | | Stage of Lactation (weeks) | | | |
|---|---|---|---|---|---|---|
| | <1000 g¹ | 1000-1500 g¹ | 0-2² | 2-4² | ≥4² | DHM^{2,3} |
| Energy kcal/100 mL | 88 ± 23 | 76 ± 16 | 58 ± 8 | 62 ± 10 | 64 ± 9 | 49 ± 5 |
| Protein g/100 mL | 2.6 ± 0.7 | 2.4 ± 0.6 | 1.7 ± 0.3 | 1.5 ± 0.2 | 1.3 ± 0.4 | 1.0 ± 0.1 |
| Fat g/100 mL | 4.6 ± 1.1 | 4.0 ± 1.0 | 3.0 ± 0.9 | 3.6 ± 1.1 | 3.8 ± 0.9 | 2.5 ± 0.3 |

¹Value calculated for a 95% confidence interval from ranges given in Table 1
²Data from Radmacher et al. (2013) as reported by Radmacher et al. (2017)
³DHM—donated human milk

Embodiments of Methods and Systems to Improve Nutritional Content in Human Derived Milk

While many formulations of milk fortifying additives are available in the marketplace a new challenge emerges in the derivation and use of milk fortifiers. Notably amongst these are the sources of protein and nutrients, with many commercial offerings deriving these nutrients from animal or plant sources. This may introduce a level of intolerance in the infant that is detrimental to overall development. There are commercially available fortifiers derived from human milk but not all the nutritional components or advantages of fresh human milk will remain after the pasteurization, fractionation, and drying necessary for the generation of a human derived milk fortifier. More consequentially, the addition of a human milk fortifier to either the mother's milk or donor milk require certain assumptions regarding the nutritional content of that milk sample that, in the case of the nutritional profile of the mother's milk, typically declines in weeks following delivery and the onset of lactation (Radmacher and Adamkin, 2017). Additionally, in part due to variability in nutritional content, specific fortification of a milk sample for each feeding can prove extremely time consuming as the volume of the milk available for the feeding, its source, and concentration of specific nutrient components must be considered (Rochow et al., 2013).

A more direct approach would be a simple-to-use milk concentrator that can extract water from human derived milk sources to increase its nutritional content. Out of a desire to preserve sensitive nutrient components in the milk such a concentration would best be done under mild conditions without imparting large amounts of shear (as noted later some shear may be beneficial) to the fluid or elevated pressure (for example ultrafiltration). One such technique would be to dewater the milk using an osmotically driven device. An advantage of this approach is that no pre-processing of the milk is needed prior to concentration and the device can be tailored such that overconcentration of the milk to an unsafe osmolality can be avoided. The typical osmolality of human milk is reported around 300 mOsm/kg (miliosmol per kilogram of water) with human milk fortified for the pre-term infant being at around 400 mOsm/kg (Ramani and Ambalavanan, 2013).

Operating Principle(s)

An osmotically driven milk separator operates on the basic biological principle of osmosis, where water from the milk is drawn across a semi-permeable membrane that it is in contact with by an osmotic pressure difference between it and a higher osmotic pressure draw solution. The draw solution can be a homogenous solution in the traditional chemistry sense, or the draw solution may instead be a mixture of powders (draw solutes) or a paste that ends up as a solution from the dissolution of solids as a result of water transport by osmosis during milk concentration. Schinkel (2015) described an osmotic milk concentrator with a sugar (e.g. sucrose, dextrose, or lactose) encapsulated within a forward osmosis membrane pouch as a powder. The forward osmosis pouch is not a technology novel to Schinkel (2015) and has traditionally comprised two pieces of semi-permeable membrane that are sealed on all (four) sides which encapsulates a dry powder of draw solutes with the majority component being sugar(s) such as sucrose, dextrose, fructose, or a mixture thereof. The purpose of these components is to exert an osmotic pressure across the semi-permeable membrane and draw water into the pouch. Schinkel (2015) describes the immersion of the forward osmosis pouch would be placed in the human milk and, by osmosis, removing water from the milk through until a desired nutrient concentration is reached. Pouches such as this have seen prior use in the batch concentration of liquid, such as in Hydration Technology Innovations, Inc.'s Wine Pouch that was used to remove water from grape must during fermentation with the goal of increasing a wine's alcohol content.

Significant drawbacks lie in the use of only sugars in a non-specific loading as the draw solute in a forward osmosis pouch for milk concentration. First amongst these is that the osmolality of a sugar loaded membrane pouch is significantly higher than preferred 400 mOsm/kg of fortified human milk. For example, at the hydration endpoint specified the solution within the forward osmosis pouch has an osmolality of 2700 mOsm/kg. This large disparity means that an unattended pouch may inadvertently over-concentrate the milk in excess of the recommended maximum osmotic pressure of 450 mOsm/kg (Ramani and Ambalavanan, 2013). A second drawback is derived from using only sugar as a draw agent, since sugar does nothing to inhibit the migration of small uncharged molecules from freely crossing the membranes. Some of these molecules (i.e. Vitamin A and phosphorous) are crucial nutrients for the pre-term infant and the concentrations of which are noticeably reduced in the milk concentrates presented in Schinkel (2015).

Embodiments for Draw Solutes Tailored to Milk Concentration

An advancement in the technology of milk concentration by forward osmosis is the use of a draw solution in a solid (i.e. mixture of powders), liquid, or paste form which is enriched with vitamins and minerals. An enriched draw solution would be tailored to balance the concentrations of more permeable milk constituents on both sides of the membrane. Because the permeation of a chemical species across a membrane is largely a factor of the concentration gradients across a membrane enrichment of the draw solution to provide a greater nutrient content in the milk concentrate, the enrichment of the draw solute would help to compensate for the imperfect permselectivity of the semi-permeable membrane with smaller uncharged molecules permeating through the membrane almost as easily as water. Besides balancing nutrients between the draw solution and milk, pH is also an important consideration is the stability of milk as it is concentrated. Human breast milk has a pH between 6.8 and 7.7 (Harrison and Peat, 1972) with a noted decrease in pH as lactation matures (Hibberd et al., 1982). Acidification of the milk during concentration is likely to occur as it concentrated since atmospheric carbon dioxide can dissolve into it. This effect would be amplified concentrating milk in the apparatus described by Schinkel as the head space in the bottle would be full of air and even if sealed a not insignificant amount of carbon dioxide will remain. A decrease in the milk's pH is undesirable because studies have noted greater bacterial counts of E. Coli in more acidic milk samples (Harrison and Peat, 1972). Because gases have greater solubility in liquids, acidification of the milk may occur faster when the sample is refrigerated to suppress milk spoilage. Acidification of the milk can be suppressed by buffering the draw solution to extract carbon dioxide by pulling it into the membrane and forming carbonate or bicarbonate. A preferred buffer for draw solution may be a potassium phosphate buffer (e.g., a combination of potassium dihydrogen phosphate and disodium hydrogen phosphate with a final draw solution concentration of 0.1 milimolal phosphate may be preferred). In addition to balancing milk pH, phosphate and potassium are both critical nutrients whose concentration gradient across the membrane can be balanced. Additionally, if the draw solution is sealed with the pouch as a powder, phosphate buffers can be loaded as a solid.

Embodiments for Mitigating Membrane Fouling

Fouling membranes presents one of the problems of membrane separations. Fouling is associated with the deposition of insoluble components on the membrane surface and presents as a sharp decline in the rate of water flow through a membrane. The membranes used in forward osmosis are typically asymmetric, characterized by a relatively smooth active layer (a.k.a. selective layer) on one side and a rougher fabric layer on the other side. This fabric layer is an integral part of the membrane's support layer and provides a significant amount of the mechanical strength for the membrane. Mitigating fouling can be achieved by selecting the membrane's orientation with respect to the milk and draw solution. Since the active layer is relatively smooth its surface is significantly more resistant to the attachment of foulants. This orientation, elsewhere referred to as the forward osmosis (FO) or active layer feed solution (AL-FS), would be the preferred orientation for fouling resistance during milk concentration.

Milk comprises of proteins, fats, and/or other solids that can deposit on a membranes surface, fouling it. Of concern in using membranes for concentrating milk is the defatting of the milk that may occur from fat adhering on the membrane. This is doubly problematic as not only will the rate of water removal from the milk slow down but it may also result in not only the loss of caloric content but also a loss of nutrients as vitamin A, vitamin D, vitamin K, and vitamin E that are fat rather than water soluble. Mitigation of fouling can be accomplished through shear by circulation, agitation, vibration, or sonication of the milk as it is concentrated. Bench evaluation of vibrating a concentrating milk sample with a forward osmosis pouch has shown a 50% improvement (0.14 kg/d non-agitated compared to 0.21 kg/d agitated) in the flowrate of water.

Embodiments for Improved Pouch Designs Tailored to Milk Concentration

Apart from improved nutrient retention by draw solution design there are routes for improving the forward osmosis pouch. The first improvement involves designing a pouch with a carefully tuned osmotic pressure. Tuning of the osmotic pressure may be to more precisely achieve a desired concentration, such as a draw solution (the draw solutes dissolved in water extracted from osmosis) targeting a 400 mOsm/kg milk concentrate would be selected so that at the end of this dilution the draw solution would be close to 400 mOsm/kg. This enhancement may greatly minimize chances of over-concentrating the milk. One challenge in developing pouches based on simple loading of solids within a pouch is the variability in lactation quantities that may be available for concentration. This may be mitigated by a preparatory dilution of the draw solution by simply placing the pouch within sterile water for a pre-determine amount of time as dictated by the desired degree of concentration and the volume of milk available for concentration.

Despite this improvement, limitations may still be present in developing single use pouches preloaded with draw solution, as there may be operational challenges in a preparatory dilution of the draw solution. Furthermore, such pouches have limited surface area available when designed to fit in the small bottles typically used for infant feeding. Improved ease of use could be achieved by incorporating the fitment of a conventional breast pump to a purpose-built membrane pouch that would serve as both the receptacle for freshly expressed milk and container for the milk's concentration. If so desired, this fitment may also be used to attach a bottle nipple and the pouch could also be used to feed in the infant.

Placing the milk within a pouch, as opposed to a pouch within the milk has a number of advantages. It increases the membrane area the milk and draw solution contact while minimizing the volume necessary. To concentrate the milk, the pouch containing the milk may also be purged of air (to reduce acidification by carbon dioxide), sealed, and placed in a reservoir of draw solution. In addition to the greater membrane surface area, this technique may allow for the concentration of multiple milk samples within a single draw solution reservoir and the draw solution reservoir could be continuously chilled. This approach may also circumvent the need for refrigeration of the milk samples (i.e. putting the milk in a refrigerator) because the chilled draw solution reservoir would be used to cool the milk and the rate of cooling of a milk sample would be improved as to liquid to air heat transfer occurring within the refrigerator would be replace with liquid to liquid heat transfer.

As another embodiment of containing the draw solution, the pouch for reception of the milk may be incorporated within a larger pouch preloaded with a sealed quantity of draw solution or having a draw solution filling port for the addition of a desired quantity of a liquid or paste draw solution. The latter approach (inclusion of a draw solution fill port as part of the construction of a large pouch) means that the amount of draw solution added can be tailored to match the amount of milk needing concentration.

Embodiments for Apparatuses Configured for Milk Concentration

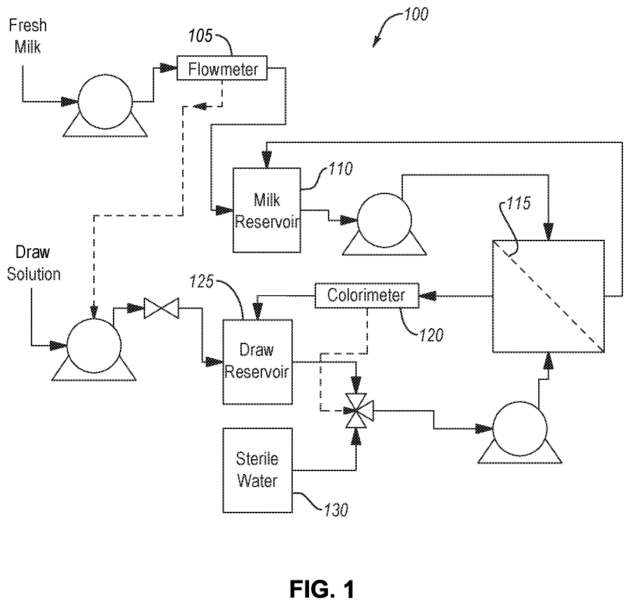

Further refinement of the pouch within a pouch concept may involve integrating that pouch as a small membrane contactor within a recirculating system. This milk concentrator apparatus would reflect the process layout common is larger forward osmosis concentrators. Unique to this milk apparatus is an acceptable disposability of the draw solution. This allows for the omission of an integrated draw solution regeneration step. This apparatus is also intended for the membrane to be single use to reduce possibility of contamination. The milk concentrator apparatus 100 according to an embodiment, illustrated in FIG. 1, is designed to be integrated with the expression of breast milk. The milk concentrator apparatus 100 may include a flowmeter 105, a milk reservoir 110, a membrane 115, a colorimeter 120, a draw reservoir 125, and sterile water 130. As milk is transferred to the concentrator milk reservoir 110, its flow will be monitored, and the draw reservoir 125 will be filled in tandem. Process control for the milk concentrator apparatus 100 comes from monitoring the draw solutions dilution as the milk is concentrated. This is done to control the osmolality of the milk as metering the draw solution means its dilution is proportional to increases in the milk's osmolality, mitigating possible human error in over-concentrating the milk. The milk concentrator apparatus 100 is configured so the draw solution will be diluted to the point where osmosis may appreciably slow to mitigate unintentional over concentration of the milk.

In addition, circulation of milk through the milk concentrator apparatus 100 discourages the adhesion of proteins and/or fat globules onto the membrane surface. As a further approach for mitigating adhesion, after the draw solution has reached a desire dilution the draw solution process lines and side contacting the membrane may be flushed with sterile water. Because of the extremely low osmotic pressure of the sterile water, the direction of osmosis across the membrane may reverse. This osmotic backflush is intended as a short duration operation to remove proteins and/or fats that may have adhered to the membrane surface while minimally impacting the nutrient content of the concentrated milk sample.

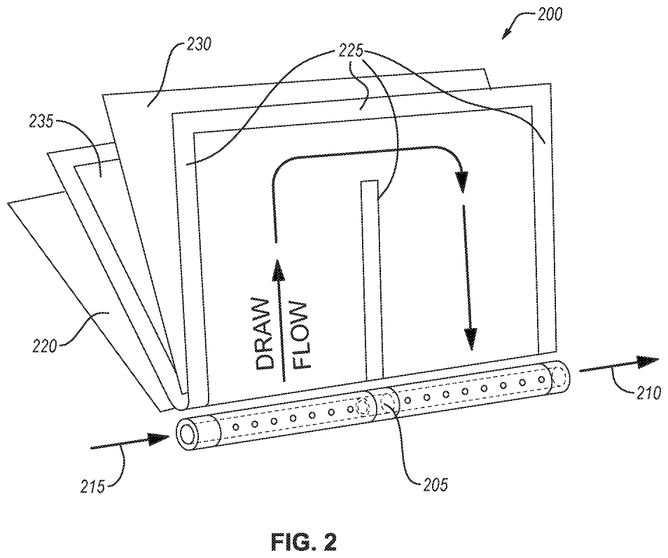

FIG. 2 shows another embodiment of a milk concentrator apparatus 200. The milk concentrator apparatus 200 also may mitigate fouling during concentrating human break milk. The milk concentrator apparatus 200 may include at least one forward osmosis membrane, such as folded membrane 235. The milk concentrator apparatus 200 also may include at least one feed spacer 230. The milk concentrator apparatus 200 also may include at least one draw or permeate spacer 220. The milk concentrator apparatus 200 also may include a core tube with an interior plug 205 around which the forward osmosis membrane, the at least one feed spacer, and the at least one draw spacer are wound. The milk concentrator apparatus 200 also may include at least one first channel through which the human breast milk flows on a first side of the at least one forward osmosis membrane. The milk concentrator apparatus 200 also may include at least one second channel through which draw solution flows on a second side of the at least one forward osmosis membrane opposite from the human milk side. The core tube has an entrance for concentrated draw solution 215 and an exit for diluted draw solution 210, with the diluted draw solution containing water removed from the human breast milk.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

References disclosed herein are incorporated herein, in their entirety, by this reference, and include:
M. S. Caplan and A. Fanaroff, 2017. “Necrotizing: A historical perspective.”
V. C. Harrison and G. Peat, 1972. “Significance of milk pH in newborne infants,” British Medical Journal 4, pp 515-518.
H. Heiman and R. J. Schanler, 2007. “Enteral nutrition for premature infants: The role of human milk,” Seminars in Fetal &Neonatal Medicine 12, pp 25-34.
C. M. Hibberd, O. G. Brooke, N. D. Carter, M. Haug, and G. Harzer, 1982. “Variation in the composition of breast milk during the first 5 weeks of lactation: Implications for the feeding of preterm infants,” Archives of Disease in Childhood 57, pp 658-662.
A. Lucas and T. J. Cole, 1990. “Breast milk and neonatal necrotising enterocolitis,” The Lancet 336, pp 1519-1523.
D. Maffei and R. J. Schanler, 2017. “Human milk is the feeding strategy to prevent necrotizing enterocolitis!” Seminars in Perinatology 41, pp 36-40.
K. McNelis, T, T. Fu, and B. Poindexter, 2017. “Nutrition for the extremely preterm infant,” Clinical Perinatology 44, pp 395-406.
J. Neu and W. A. Walker, 2011. “Necrotizing enterocolitis,” New England Journal of Medicine 364, pp 255-264.
R. M. Patel and P. W. Denning, 2013. “Therapeutic use of prebiotics, probiotics, and postbiotics to prevent necrotizing enterocolitis: What is the current evidence?” Clinical Perinatology 40, 11-25.
P. G. Radmacher and D. H. Adamkin, 2017. “Fortification of human milk for preterm infants,” Seminars in Fetal & Neonatal Medicine 22, pp 30-35.
P. G. Radmacher, S. L. Lewis, and D. H. Adamkin, 2013. “Individual fortification of human milk using real time human milk analysis,” Journal of Neonatal-Perinatal Medicine 6, pp 319-323.
M. Ramani and N. Ambalavanan, 2013. “Feeding practices and nectrotizing enterocolitis,” Clinical Perinatology 40, 1-10.
N. Rochow, G. Fusch, A. Choi, L. Chessell, L. Elliott, K. McDonald, E. Kuiper, M. Purcha, S. Turner, E. Chan, M. Y. Xia, and C. Fusch, 2013. “Target fortification of breast milk with fat, protein, and carbohydrates for preterm infants,” The Journal of Pediatrics 163, pp 1001-1007.
E. R. Schinkel, 2015. “Method and apparatus for fortifying breast milk,” US patent application US2015/0208681A1, Jul. 30, 2015.
R. Sharma and L. Hudak, 2013. “A clinical perspective on necrotizing enterocolitis: Past, present, and future.” Clinical Perinatology 40, pp 27-51.
B. H. Su, 2014. “Optimizing nutrition in preterm infants,” Pediatrics and Neonatology 55, pp 5-13.
R. C. Tsang, R. Uauy, B. Koletzko, and S. Zlotkin, 2005. Nutrition of the preterm infant: Scientific, basic, and practical guidelines, Digital Education Publishing Inc., Cincinnati, Ohio
D. Tudehope, M. Fewtrell, S. Kashyap, and E. Udaeta, 2013. “Nutritional needs of the micropreterm infant,” The Journal of Pediatrics 162, pp S72-S80.

What is claimed is:

1. A method of concentrating human breast milk to increase nutritional content of the human breast milk per unit of volume or immunological content of the human breast milk per unit of volume thereof, the method comprising:
using an osmotic pressure difference between the human breast milk and one or more draw materials to concentrate the human breast milk, the one or more draw materials including at least one of a buffer, one or more sugars, one or more minerals, one or more salts, one or more proteins, one or more amino acids, or one or more fatty acids;
wherein the osmotic pressure difference occurs across at least one membrane, the at least one membrane separating the human breast milk from the one or more draw materials such that water is removed from the human breast milk and transferred across the at least one membrane, and into the one or more draw materials;
wherein material of the at least one membrane limits transfer of the one or more draw materials across the at least one membrane into the human breast milk to acceptable safe levels for feeding the human breast milk to an infant;
wherein the material of the at least one membrane limits transfer of human breast milk components across the at least one membrane, thereby reducing loss of nutrients or immunological components in the human breast milk.

2. The method of claim 1, wherein the material of the at least one membrane transfers at least a portion of lactose in the human breast milk, thereby preventing overconcentration of lactose in the human breast milk.

3. The method of claim 1, wherein the material of the at least one membrane includes at least one of cellulose or cellulose ester.

4. The method of claim 1, wherein the material of the at least one membrane is spiral wound, thereby providing a larger surface contact area to enhance transfer of the water out of the human breast milk.

5. The method of claim 4, further comprising subjecting the human breast milk to a pressure of less than 30 psi to enhance flow of the human breast milk through the at least membrane that is spiral wound.

6. The method of claim 1, wherein the material of the membrane is formed into an enclosure which holds at least one of the draw material or the human breast milk.

7. The method of claim 1, further comprising collecting the human breast milk from the mother of the infant for which the human breast milk is intended.

8. The method of claim 1, further comprising the human breast milk comes from one or more human milk donors that are not the mother of the infant for which the human breast milk is intended.

9. The method of claim 1, further comprising providing instruction to the user to agitate, vibrate, sonicate, mix or otherwise enhance circulation of at least one of the human breast milk or the one or more draw materials, thereby mitigating fouling of the membrane by generating shear in a membrane pouch exerted on the breast milk, the draw solution, or both.

10. An apparatus, comprising:
at least one draw material reservoir including one or more draw materials, the one or more draw materials including at least one of a buffer, one or more sugars, one or more minerals, one or more salts, one or more proteins, one or more amino acids, or one or more fatty acids;
at least one human milk reservoir; and
at least one semi-permeable membrane between the at least one draw material reservoir and the at least one human milk reservoir.

11. The apparatus of claim 10, wherein the at least one semi-permeable membrane is formed into at least one pouch with at least one of the at least one draw material or the human milk reservoir being inside the at least one pouch, wherein the at least one draw solution reservoir and the at least one human milk reservoir contact opposite sides of the at least one semi-permeable membrane.

12. The apparatus of claim 11, wherein:
the at least one pouch includes multiple pouches formed from the at least one semi-permeable membrane, the multiple pouches being tethered to one another, independent of one another, or a combination thereof; and
at least one of the multiple pouches includes that least one draw material therein.

13. The apparatus of claim 11, wherein the at least one pouch includes the human milk reservoir.

14. The apparatus of claim 10, wherein the at least one semi-permeable membrane includes at least one of cellulose or cellulose ester.

15. The apparatus of claim 10, wherein the one or more draw materials include at least one of a powder, a paste, or a solution.

16. The apparatus of claim 15, wherein the one or more draw material is tailored or metered such that a maximum osmolality of the human breast milk is 400 mOsm/kg.

17. The apparatus of claim 10, wherein the at least one draw material reservoir includes an active membrane surface area positioned to be exposed to human milk in the at least one milk reservoir, the active membrane surface area being at least 50 square centimeters.

18. The apparatus of claim 10, wherein:
the at least one semi-permeable membrane is formed into a spiral wound element having one or more first flow channels for human milk and one or more second flow channels for a draw solution;
the at least one draw material reservoir and the at least one human milk reservoir connect to opposite sides of the spiral wound element of the at least one semi-permeable membrane;
the one or more first flow channels and the one or more second flow channels form paths along which water from the human milk crosses the at least one semi-permeable membrane and mixes with the draw solution, thereby diluting the draw solution and concentrating the human milk.

19. An apparatus for mitigating fouling during concentrating human breast milk, the apparatus comprising:
at least one forward osmosis membrane;
at least one feed spacer;
at least one draw spacer;
a core tube with an interior plug around which the forward osmosis membrane, the at least one feed spacer, and the at least one draw spacer are wound;
at least one first channel through which the human breast milk flows on a first side of the at least one forward osmosis membrane; and
at least one second channel through which draw solution flows on a second side of the at least one forward osmosis membrane opposite from the human milk through which the draw solution flows;
wherein the core tube has an entrance for concentrated draw solution and an exit for diluted draw solution with the diluted draw solution containing water removed from the human breast milk.

20. The apparatus of claim 19, wherein spacing and configuration of the first side of the at least one forward osmosis membrane creates velocity of the human milk thereby creating shear that mitigates fouling.
